(19) United States
(12) Patent Application Publication
(10) Pub. No.: US 2019/0223080 A1
(43) Pub. Date: Jul. 18, 2019

(54) METHOD AND APPARATUS FOR RESTRICTING NETWORK ACCESS

(71) Applicant: MOTOROLA SOLUTIONS, INC, Chicago, IL (US)

(72) Inventors: Mariusz R. WAWROWSKI, WAWRZENCZYCE (PL); Andri Olekandrovych BEREGOVENKO, KRAKOW (PL); Rafal Jan KAMINSKI, KRAKOW (PL); Sebastian Lis LIS, KRAKOW (PL); Grzegorz SZYSZKA, KRAKOW (PL); Dominik WOJTASZEK, DEBICA (PL)

(73) Assignee: MOTOROLA SOLUTIONS, INC., Chicago, IL (US)

(21) Appl. No.: 16/307,001

(22) PCT Filed: Sep. 22, 2016
(86) PCT No.: PCT/PL2016/050042

§ 371 Date: Dec. 4, 2018

(51) Int. Cl. H04W 48/04; H04W 4/021

(52) U.S. Cl. CPC H04W 48/04; H04W 4/022

(57) ABSTRACT

A method and apparatus for restricting network access is provided herein. More particularly, when an officer operates in a covert mode, a geofence boundary will be set to surround a device associated with the officer. Devices not associated with the officer will have their network access restricted if they are determined to exist within the geofence.

### FIELD OF THE INVENTION

The present invention generally relates to restricting network access, and in particular, to a method and apparatus for restricting network access as part of a covert mode of operation.

### BACKGROUND OF THE INVENTION

Many times public-safety officers operate in a “covert mode” in order to protect their identity, or prevent other individuals from discovering that a special operation is in progress. For example, a police officer may play the role of a citizen as part of an illegal drug operation or for a prostitution sting. Obviously, when an officer is operating in a covert mode, it is essential that their true identity remain unknown by anyone they are investigating.

Covert mode operation is becoming more and more dangerous because of the many ways available now to quickly identify an individual. For example, a person may be identified by using any number of network resources (both public and private). Various internet search engines can identify individuals by use of a picture. Other network search engines are capable of identifying individuals by using a recording of their voice, and obviously, car license plate numbers can be input into a database to identify the owner of a car.

With all of the ways available to identify individuals, it would be beneficial if the possibility of discovery is reduced when an officer is operating in a covert mode. Therefore, a need exists for a method and apparatus for restricting network access as part of a covert mode of operation.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless communications network in accordance with some embodiments.

FIG. 2 is a block diagram of a geofence server in accordance with some embodiments.

FIG. 3 illustrates setting a geofence boundary.

FIG. 4 is a flow chart showing operation of the geofence server of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In order to address the above-mentioned need, a method and apparatus for restricting network access is provided herein. More particularly, when an officer operates in a covert mode, a geofence boundary will be set to surround a device associated with the officer. Various devices not associated with the officer will have their network access restricted if they are determined to exist within the geofence.

Restricting network access as described above lessens the chances that an officer will be “discovered” when operating in a covert mode. More particularly, because network access is restricted for devices within the geofence surrounding the officer, persons currently under investigation will not be able to perform a network search in an attempt to identify the officer.

As an example consider a situation where an officer is under cover attempting to purchase drugs from a drug dealer. When the officer indicates that they are operating in a covert mode, network access may be restricted for anyone within 300 meters of the officer (including the drug dealer). As a result, if the drug dealer becomes suspicions, and attempts to use their mobile phone to perform a network search of the officer, they will be unable to do so.

It should be noted that restricting network access may take the form of:
restricting all network access for a device such that no voice or data is allowed to be transmitted to the device;
restricting some network access, but allowing other network access to remain (for example, restricting all data use, but allowing voice communications to take place);
restricting access to various web addresses (such as search engines), so that if a device attempt to access a particular web address, the attempt is blocked by the network; and/or
restricting or spoofing search results at a search engine when the search request is received from a device within the geofence.

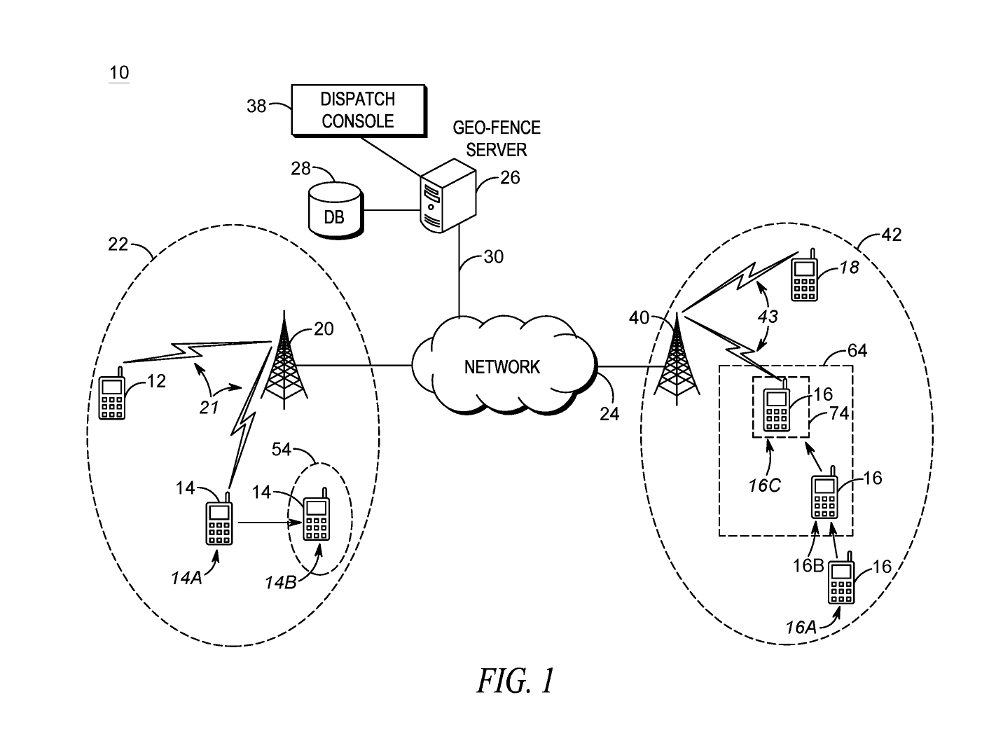

FIG. 1 illustrates a communications environment 10 including radios (subscriber devices) 12, 14, 16, 18, fixed terminals 20, 40 (e.g. base stations), wireless links 21, 43, backhaul network 24, geofence server 26, database 28, communications connection 30, and dispatch console 38. Each base station 20, 40 has at least one radio transmitter covering a radio coverage cell (22, 42). One or several radios 12, 14, 16, 18 within radio coverage cells 22, 42 of the respective base stations 20, 40 may connect to the base stations 20, 40 using a wireless communication protocol via respective wireless links 21, 43. The radios 12, 14, 16, 18 may communicate with each other, and perhaps other devices accessible via other network links, using a group communications protocol over wireless links 21, 43. Wireless links 21, 43 may be, for example, a wireless link supporting any network protocol (e.g., any cellular communication protocol, or any public-safety communication system protocol). Base stations 20, 40 may comprise base stations on different networks or the same network. For example, base station 20 may comprise a base station utilizing a 4G cellular communication system protocol, while base station 40 may comprise a base station using a private 802.11 communication system protocol. The radios 12, 14, 16, 18 may be configured with an identification reference (such as an IMSI, International Mobile Subscriber Identity, or an SUID, Subscriber Unit Identifier) which may be connected to a physical media (such as a SIM card, Subscriber Identity Module).

Each radio 12, 14, 16, 18 may be a group communications device, such as a push-to-talk (PTT) device, that is normally maintained in a monitor only mode, and which switches to a transmit-only mode (half-duplex) or transmit and receive mode (full-duplex) upon depression or activation of a PTT input switch. The group communications architecture in communication environment 10 allows a single radio, such as radio 14, to communicate with one or more members (such as radios 12, 16-18) associated with a particular group of radios at the same time. Radios 12, 14, 16, 18, base stations 20, 40, and/or an infrastructure controller (not shown) may cooperate to define groups of radios and enable the one-to-many communications feature provided by communication environment 10. As radios are mobile, they may move within, into, out of, and/or between radio coverage cells 22, 42. For example, radio 14 may move from an initial location 14A within radio coverage cell 22 to a subsequent location 14B also within radio coverage cell 22. Similarly, radio 16 may move from an initial location 16A outside of radio coverage cell 42 to a secondary location 16B within radio coverage cell 42, and then to a final location 16C also within radio coverage cell 42.

Although only four radios and two base stations are illustrated in FIG. 1, the present disclosure is not limited as such, and more or fewer radios and more or fewer base stations from multiple differing networks could be used in any particular implementation. Furthermore, while a single geofence server 26 is illustrated in FIG. 1, more than one geofence server 26 may be used and/or a distributed geofence server 26 may be used that divides functions across multiple devices, perhaps for load balancing reasons. Finally, while database 28 is illustrated as directly coupled to geofence server 26, database 28 may also be remote from geofence server 26 and accessible to geofence server 26 via one or more of network 24 and/or external networks 34.

The base stations 20, 40 may be linked to the geofence server 26 via network 24 and communications connection 30. Network 24 may comprise one or more routers, switches, LANs, WLANs, WANs, access points, or other network infrastructure. For example, geofence server 26 may be accessible to base stations 20, 40 via a dedicated wireline or via the Internet. In one example, base stations 20, 40 may be directly coupled to geofence server 26 via one or more internal links under control of a single communications network provider.

Geofence server 26 may be a separate device or may lie internal other network equipment. Server 26 is configured to maintain a database of geofence definitions (i.e., current location and/or boundaries of a particular geofence, current location and a distance for a particular device having a geofence surrounding it, and/or a type of network restriction for the geofence). Geofence server 26 may provide mechanisms and/or interfaces for activating or de-activating existing geofences it is maintaining, for adding new geofence definitions, and for deleting existing geofence definitions. Geofence server 26 may also comprise an application running at the dispatch center (dispatch console 38). The geofence server 26 may further maintain mappings that identify, for each active geofence in the database, a corresponding network restrictions for various radios within the geofence (e.g., various radios may be configured to restrict network access by restricting access to various web sites when within a geofence). In other embodiments, geofence server 26 may be embodied within or coupled to another network device, such as a base station controller (BSC), mobile switching center (MSC), site controller, zone controller, Push-to-Talk controller, or other network device, inside network 24 or outside of network 24.

Geofence server 26 may be fed location updates for all radios and restrict network access to various radios based on their location within one or more geofences. In another embodiment, server 26 may simply provide geofence radio parameters and boundary information to each radio, and have the radios themselves restrict network access.

As is evident, geofences may be mobile. Because of this, geofence server 26 will need to be provided continuous updates of locations for radios. For example, a geofence may be created so that various devices within a predetermined distance from a particular vehicle/device have their access to a network restricted. Since the geofence will move with the particular vehicle/device, frequent updates for the vehicle/device location will need to be provided to geofence server 26.

Database 28 may function to store geofence locations, device locations, and/or type of network access restriction, and provide this information, upon request, to geofence server 26. For example, database 28 may store a first geofence definition (geofence area and radio restrictions) defining a first geofence 54 within radio coverage cell 22 and associated with base station 20, a second geofence definition defining a second geofence 64 that is partially within radio coverage cell 42 and associated with base station 42 (and perhaps another, adjacent base station, not shown), and a third geofence definition defining a third geofence 74 that is within (e.g., a sub-region of) geofence 64 and radio coverage cell 42 and is also associated with base station 40.

Geofence definitions may be unique to each radio/individual and include a set of three or more polygon vertices, where each polygon vertex is a GPS coordinate, such as latitude and longitude pair, or some other form of cartographic definition. Additionally or alternatively, geofence definitions may include a point and radius, where the radius is a distance criterion and the point is a GPS coordinate (which may be in motion), such as a latitude and longitude pair, or some other form of cartographic definition. Further, geofence definitions may include of a set of two diagonally opposing rectangular vertices, where each rectangular vertex is a GPS coordinate (which may be in motion), such as a latitude and longitude pair, or some other form of cartographic definition. Other possibilities exist as well.

Communication environment 10 may include a narrow-band trunked radio communication system in which radios 12, 14, 16, 18 transmit control and data messages in accordance with an air interface protocol such as that defined by the ETSI Digital Mobile Radio (DMR), Terrestrial Trunked Radio (TETRA), or Association of Public-Safety Communications Officials 25 (APCO P25) standards. In a trunked radio communication system, frequencies are assigned for talk group use on an as-needed basis, and signaling over a control channel is used to direct radios to a particular channel to receive a particular group communication. In another embodiment, communication environment 10 may implement a PTT over Cellular (OMA-PoC) or PTT over IP (PoIP) broadband architecture in which radios 12, 14, 16, 18 transmit control and data messages in accordance with a protocol such as real-time transport protocol (RTP) and/or session initiation protocol (SIP). In yet another embodiment, communication environment 10 may include multiple networks operating under various communication system protocols, with geofence server providing data regarding geofences to the various networks.

Dispatch console 38 lies within a dispatch center (not shown) and may be directly coupled to geofence server 26 as shown, or may be indirectly coupled to geofence server 26 via one or more of network 24 and external networks 34. The dispatch console 38 may provide an administrative or dispatch access to radios 12, 14, 16, 18 and geofence server 26, and allow an administrator or dispatcher to initiate infrastructure-sourced group communications to groups of radios 12, 14, 16, 18, among other features and functions.

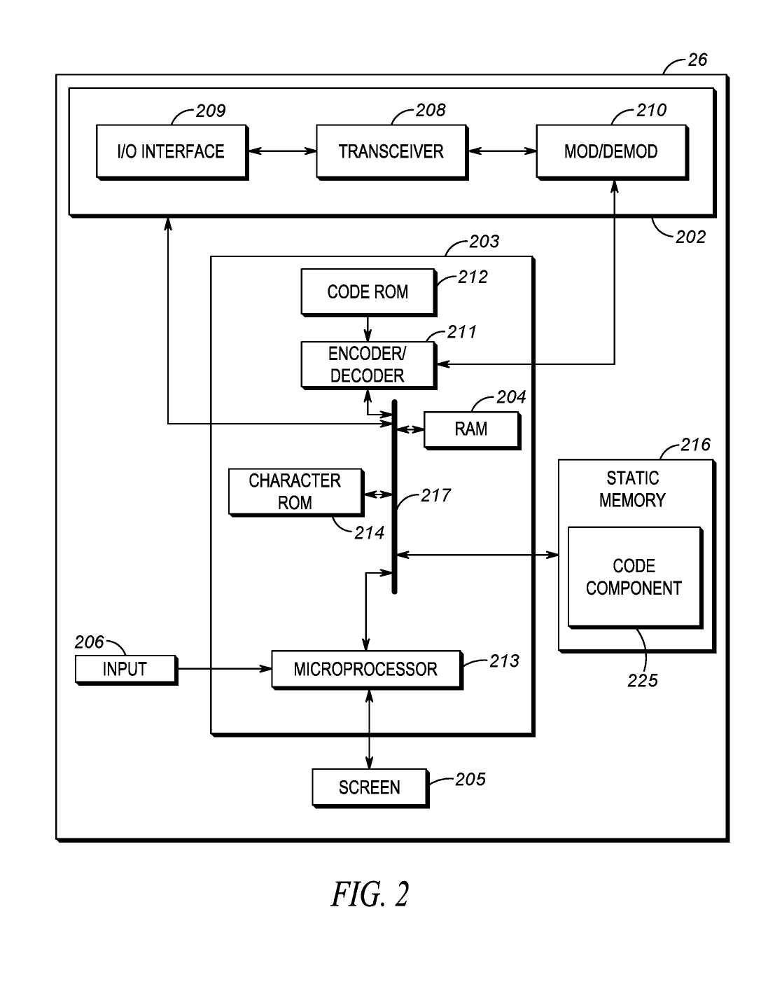

Referring to FIG. 2, a schematic diagram illustrates a geofence server 26 according to some embodiments of the present disclosure. Geofence server 26 may be, for example, the same as or similar to the geofence server 26 of FIG. 1. As shown in FIG. 2, geofence server 26 includes a communications unit 202 coupled to a common data and address bus 217 of a processing unit 203. The geofence server 26 may also include an input unit (e.g., keypad, pointing device, etc.) 206 and a display screen 205, each coupled to be in communication with the processing unit 203.

The processing unit 203 may include an encoder/decoder 211 with an associated code Read Only Memory (ROM) 212 for storing data for encoding and decoding voice, data, control, or other signals transmitted or received by geofence server 26. The processing unit 203 may further include a microprocessor 213 coupled, by the common data and address bus 217, to the encoder/decoder 211, a character ROM 214, a Random Access Memory (RAM) 204, and a static memory 216.

The communications unit 202 may include one or more wired or wireless input/output (I/O) interfaces 209 that are configurable to communicate with BSs such as BSs 20, 40 of FIG. 1, with other devices in the communication environment 10, and/or with the dispatch console 38. The communications unit 202 may include one or more wireless transceivers 208, such as a DMR transceiver, an APCO P25 transceiver, a TETRA transceiver, a Bluetooth transceiver, a Wi-Fi transceiver perhaps operating in accordance with an IEEE 802.11 standard (e.g., 802.11a, 802.11b, 802.11g), a cellular communication transceiver, a WiMAX transceiver perhaps operating in accordance with an IEEE 802.16 standard, and/or other similar type of wireless transceiver configurable to communicate via a wireless network. The communications unit 202 may alternatively or additionally include one or more wireline transceivers 208, such as an Ethernet transceiver, a Universal Serial Bus (USB) transceiver, or similar transceiver configurable to communicate via a twisted pair wire, a coaxial cable, a fiber-optic link or a similar physical connection to a wireline network. The transceiver 208 is also coupled to a combined modulator/demodulator 210 that is coupled to the encoder/decoder 211.

The microprocessor 213 has ports for coupling to the input unit 206 and to the display screen 205. The character ROM 214 stores code for decoding or encoding data such as control channel messages and/or data or voice messages that may be transmitted or received by the geofence server 26. Static memory 216 may store operating code 225 for the microprocessor 213 that, when executed, performs one or more of the steps described with respect to changing geofence boundaries and restricting network access as described herein. Static memory 216 may comprise, for example, a hard-disk drive (HDD), an optical disk drives such as a compact disk (CD) drive or digital versatile disk (DVD) drive, a solid state drive (SSD), a tape drive, a flash memory drive, or a tape drive, to name a few.

As discussed above, covert mode operation is becoming more and more dangerous because of the many ways now available to quickly identify an individual. With all of the ways available to identify individuals, it would be beneficial to reduce the possibility that an officer may be “discovered” when they are operating in a covert mode. This may be accomplished by restricting access to any network for individuals who may perform a search to try to identify the officer.

In order to accomplish the above, communication unit 202 will receive an indication that a particular device is in cover mode. In particular, a user may navigate through a menue on their device, and select an option for covert-mode operation. Selecting the covert-mode operation will cause the device to message server 26 requesting a geofence be set up in order to restrict network access as described herein. In addition, continuous updates (e.g., once every 30 seconds) of the particular devices location will be received by communication unit 202 and stored in memory 216. Microprocessor 213 will receive the indication and provide the notification to any user via screen 205. Microprocessor 213 will then maintain a geofence surrounding the particular device.

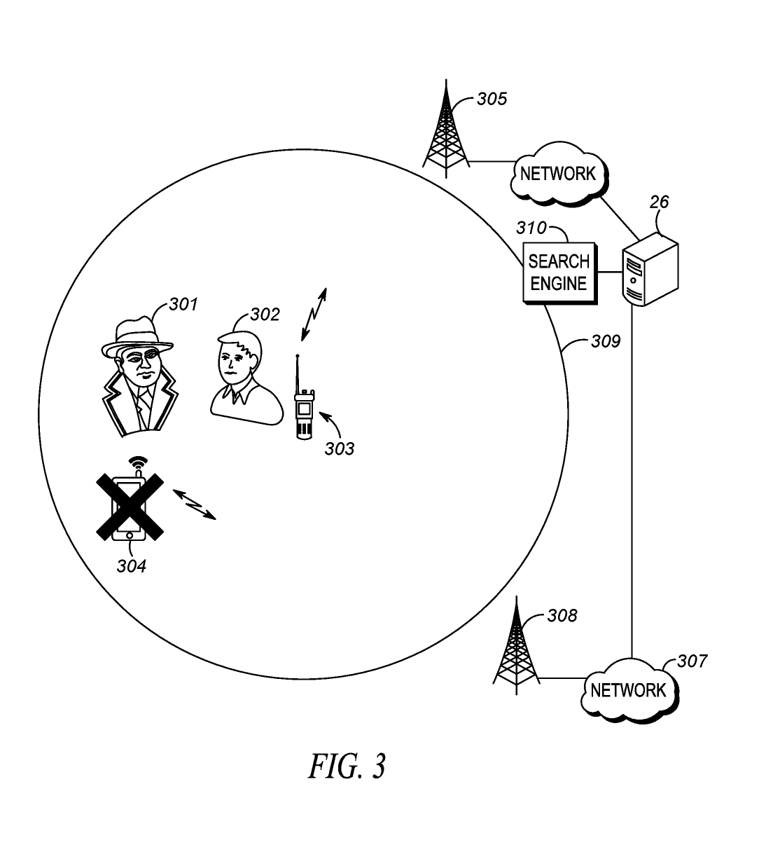

In order to restrict network access for various devices within the geofence, various networks will need to be informed of the geofence. With this in mind, microprocessor 213 determines those networks within the vicinity of the geofence and instructs communication unit 202 to provide the geofence definition to the various networks. For example, multiple cellular networks may be provided the geofence definition and restrict network access to individuals within the geofence. In addition to providing the geofence definition to the various networks, the geofence definitions may be provided directly to servers running various search engines. The search engines may then restrict searches if a search originates from within a geofence. This is illustrated in FIG. 3.

FIG. 3 shows officer 302 with associated device 303. Device 303 may comprise a police radio or any subscriber device (e.g., a smart phone) associated with officer 302. Criminal 301 is shown with associated device 304. Again, device 304 may comprise any subscriber device such as, but not limited to a smart phone, a laptop computer, a tablet computer, . . . , etc. Officer 302 may indicate a covert mode operation by instructing device 303 to transmit an appropriate message to geofence server 26. More particularly, device 303 may send a message to a first access point 305 associated with a first network 306 (e.g., a base station 305 coupled to a public-safety network 306). Public-safety network 306 will provide the message to geofence server 206.

Geofence server 206 receives the message that device 303 wishes to operate using a covert mode, and sets up a geofence 309 surrounding device 303. In a preferred embodiment of the present invention the geofence 309 comprises an area surrounding device 303 (e.g., an area within 100 feet of device 303). Geofence server 26 will provide the geofence 309 to a second network 307 and possibly a second server (e.g., search engine 310). Second network 307 comprises, for example, a 4G cellular communications network operated by a public operator. Network 307 and search engine 310 will then restrict network access for all devices within the geofence. For example, geofence server 26 will provide the location of geofence 309 to a network controller (not shown in FIG. 3). The network controller will then restrict network access for any devices within geofence 309. So, for example, device 304 which may be operated by criminal 301 will have its network access restricted as described above. In a similar manner, geofence server 26 will provide the location of geofence 309 to search engine 310. Search engine 310 will restrict access for all searches that originate within geofence 309.

It is assumed that device 304 and device 303 will continuously provide updates of their locations so that an accurate geofence may be maintained, and that network access can be restricted accordingly.

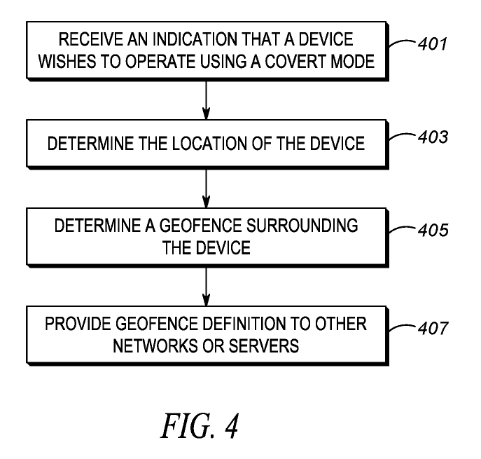

FIG. 4 is a flow chart showing operation of the geofence server of FIG. 2. The logic flow begins at step 401 where communication unit 202 receives an indication that a device wishes to operate using a covert mode. This indication may simply be a voice communication from communication unit 202, or may be something more “covert”, like a data message transmitted from a device after the device received a notification from the user that the user wanted to operate using a covert mode. In a first embodiment of the present invention, the indication is received over a first communication system such as a public-safety communication system using a first over-the-air network.

At step 403 a location of the device is determined. More particularly, as discussed above, the device will periodically transmit its location to geofence server 26. This location will be received in the form of a message received by communication unit 202. The location will be passed to logic circuitry (microprocessor 213). Logic unit 213 uses the location to determine a geofence (a geofence definition) surrounding the device (step 405). Finally, at step 407, logic circuitry 213 instructs communication unit 202 to provide a geofence definition to networks and/or servers so that network access is restricted for at least a second device operating on a second network within the geofence. As discussed, the geofence definition may comprise information on a location of the geofence and a type of network restriction, or simply comprise information on a location of the geofence and an indication that network access should be restricted.

As discussed above, the second device may operate on a second network, differing from the first network, and the network access is restricted on the second network. The network access can be restricted by limiting access to search engines, by limiting access to certain internet addresses, and/or by limiting data transmitted to the second device.

In order to accomplish the above, an apparatus is provided (geofence server 26) which comprises a communication unit receiving an indication over a first network that a device wishes to operate using a covert mode, logic circuitry determining a location of the device and determining a geofence surrounding the device, and the communication unit providing a geofence definition to a second network so that network access to the second network is restricted for at least a second device operating within the geofence. As discussed, the network access is restricted by limiting access to search engines, by limiting access to certain internet addresses, and/or by limiting data transmitted to the second device.

In the foregoing specification, specific embodiments have been described. However, one of ordinary skill in the art appreciates that various modifications and changes can be made without departing from the scope of the invention as set forth in the claims below. For example, the above description was provided with the geofence server providing a geofence definition to various network entities, and the network entities themselves restricting network access. For example the above description provided for a search engine to receive the geofence definition and restrict access to searches coming from within the geofence. However, one of ordinary skill in the art will recognize that the geofence server itself may be equipped to restrict network access as described above, Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for restricting network access, the method comprising the steps of:
receiving an indication that a device wishes to operate using a covert mode;
determining a location of the device;
determining a geofence surrounding the device; and
providing a geofence definition to networks and/or servers so that network access is restricted for at least a second device operating within the geofence.

2. The method of claim 1 wherein the step of receiving the indication comprises the step of receiving the indication from the device via an over the air first network.

3. The method of claim 2 wherein the second device operates on a second network, differing from the first network, and the network access is restricted on the second network.

4. The method of claim 1 wherein the network access is restricted by limiting access to search engines.

5. The method of claim 1 wherein the network access is restricted by limiting access to certain internet addresses.

6. The method of claim 1 wherein the network access is restricted by limiting data transmitted to the second device.

7. The method of claim 1 wherein the geofence definition comprises information on a location of the geofence and a type of network restriction.

8. The method of claim 1 wherein the geofence definition comprises information on a location of the geofence and an indication that network access should be restricted.

9. A method for restricting network access, the method comprising the steps of:
receiving an indication over a first network that a device wishes to operate using a covert mode;
determining a location of the device;
determining a geofence surrounding the device;
providing a geofence definition to a second network so that network access to the second network is restricted for at least a second device operating within the geofence; and
wherein the network access is restricted by limiting access to search engines, by limiting access to certain internet addresses, and/or by limiting data transmitted to the second device.

10. The method of claim 9 wherein the geofence definition comprises information on a location of the geofence and a type of network restriction.

11. The method of claim 9 wherein the geofence definition comprises information on a location of the geofence and an indication that network access should be restricted.

12. An apparatus comprising:
a communication unit receiving an indication over a first network that a device wishes to operate using a covert mode;
logic circuitry determining a location of the device and determining a geofence surrounding the device;
the communication unit providing a geofence definition to a second network so that network access to the second network is restricted for at least a second device operating within the geofence; and
wherein the network access is restricted by limiting access to search engines, by limiting access to certain internet addresses, and/or by limiting data transmitted to the second device.
